(19) United States
(12) Patent Application Publication
(10) Pub. No.: US 2023/0314733 A1
(43) Pub. Date: Oct. 5, 2023

(54) SELF-DOCKING SELF-ALIGNED OPTICAL PCB CONNECTOR FOR SEMICONDUCTOR PACKAGES

(71) Applicant: Intel Corporation, Santa Clara, CA (US)

(72) Inventors: Eric MORET, Beaverton, OR (US); Paul DIGLIO, Gaston, OR (US); Wesley MORGAN, Lake Oswego, OR (US)

(21) Appl. No.: 17/710,669

(22) Filed: Mar. 31, 2022

(51) Int. Cl. G02B 6/42

(52) U.S. Cl. CPC G02B 6/4214; G02B 6/4245; G02B 6/428; G02B 6/4257

(57) ABSTRACT

Embodiments disclosed herein include an electronic system. In an embodiment, the electronic system comprises a board, and a package substrate coupled to the board. In an embodiment, a photonics integrated circuit (PIC) is coupled to the package substrate. In an embodiment, an optical lens is on the PIC, and an optical connector is on the board. In an embodiment, the optical connector passes through an opening through the package substrate and is optically coupled with the optical lens on the PIC.

### TECHNICAL FIELD

Embodiments of the present disclosure relate to electronic packages, and more particularly to electronic packages with self-docking, self-aligned PCB connectors.

### BACKGROUND

Photonics packaging presents technical challenges which translate into high assembly cost, with challenges related in particular to the package optical interface assembly. Current approaches rely on carefully aligning and gluing optical fiber bundles onto the photonics integrated circuit (PIC). These package and interface schemes are not suitable for high volume manufacturing.

Generally, the current approach is for a photonics package interface to include directly coupling the optical fibers to the PIC. The coupling is achieved by placing and gluing optical fibers into V-grooves etched into the edge of the PIC. Previous solutions to this laborious process consist mostly on improving the assembly process (e.g., faster cure adhesive), tool architecture (e.g., higher parallelism, faster alignment, etc.), and tooling materials (e.g., bond head, media, etc.).

### BRIEF DESCRIPTION OF THE DRAWINGS

FIG. 1A is a cross-sectional illustration of a photonics integrated circuit (PIC) package with an interposer and a board, in accordance with an embodiment.

FIG. 1B is a cross-sectional illustration of the PIC coupled to the board, in accordance with an embodiment.

FIG. 2A is a cross-sectional illustration of a PIC package without an interposer and a board, in accordance with an embodiment.

FIG. 2B is a cross-sectional illustration of the PIC coupled to the board, in accordance with an embodiment.

FIG. 3A is a cross-sectional illustration of an optical connector interfacing with an interposer below the PIC, in accordance with an embodiment.

FIG. 3B is a cross-sectional illustration of an optical connector with an alignment feature that is offset from the lens of the optical connector, in accordance with an embodiment.

FIG. 3C is a cross-sectional illustration of an optical connector that includes an alignment feature that interfaces with a protrusion on the PIC, in accordance with an embodiment.

FIG. 3D is a cross-sectional illustration of an optical connector that is aligned with an edge lens on the PIC, in accordance with an embodiment.

FIG. 3E is a cross-sectional illustration of an optical connector that is aligned with an edge lens on the PIC, and where the optical connector lens is co-located with the alignment feature, in accordance with an embodiment.

FIG. 3F is a cross-sectional illustration of an optical connector that is aligned with an edge lens on the PIC, and where the optical connector lens is offset from the alignment feature, in accordance with an embodiment.

FIG. 4 is a cross-sectional illustration of a PIC with a plurality of lenses that is aligned with an optical connector, in accordance with an embodiment.

FIG. 5 is a schematic of a computing device built in accordance with an embodiment.

### EMBODIMENTS OF THE PRESENT DISCLOSURE

Described herein are electronic packages with self-docking, self-aligned PCB connectors, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, existing processes to couple a photonics integrated circuit (PIC) with optical fibers includes the labor intensive process of aligning and gluing the optical fibers into V-grooves on the PIC. This requires tight positional tolerances (e.g., 1 μm or less) by the assembly tools. This often also includes the need for active (optical feedback based) alignment, which results in low throughputs and complex integration challenges. Such integration issues make such assembly non-compatible with high volume manufacturing (HVM) environments. Also, it makes scaling to larger PIC counts per package difficult.

The previous solutions also require larger PIC dies. This is because space is needed for the formation of the V-grooves. In some instances, the additional area needed for the V-grooves can account for approximately ten percent or more of the total die area. As such, the cost of the PIC dies is increased.

It is to be appreciated that previous solutions are not scalable with respect to the number of PICs and fibers the assembly process needs to assemble. In some instances, the package product presents fiber dongles protruding on two sides which can be accommodated in the media and tools. However, extending to optical connections on four sides of the package would break the current tooling and processes.

Furthermore, the current process does not account for yield-loss of the expensive fiber array unit (FAU) attachments. If the FAU is attached unsuccessfully, the loss likely will not be discovered until after completed assembly. This results in both the unit-level (CPU) loss and all attached FAUs, which are considerably costly components.

Accordingly, embodiments disclosed herein overcome the above shortcomings by fully integrating the optical connector into the package socket (LGA) or board-side (BGA) that interfaces mechanically with a substrate. The optical coupling between the fiber and the PIC is done through the use of expanded beam coupling. The combination makes for a low loss and more robust (i.e., less precision dependent) scalable interface between the package (PIC-side) and the outside world (fiber-side).

In an embodiment, novel integration of a substrate (e.g., a package substrate or a package substrate and an interposer) that presents a novel mechanical alignment receiving landing zone for a fiber connector is provided. In an embodiment, the architecture includes a substrate with an opening through which light can travel to and from the PIC in an expanded beam form (i.e., through free space coupling). Additionally, the fiber connector has a lensing system and a mechanical mating feature to the substrate for alignment. The optical connector has some near full mobility degrees of freedom within a limited range, which allows the fiber connector to align itself to the package. Therefore, the PIC is properly aligned with the fiber connector upon mere socketing of the package (or attach process for a BGA architecture).

Embodiments disclosed herein allow for free-space coupling at the bottom of the package. This provides both customer and package test entities with a virtually identical form factor to current packages. As such, there is simplified handling, interfacing, and maintenance. Essentially, embodiments allow a drop-in socket that is not very susceptible to human mishandling and/or user error. Such a pluggable fiber connector also enables the low loss of direct-to-PIC fiber connection approaches for the best performance while enabling field replaceable parts (separate package from FAU) and debug options (swapping FAUs).

In an embodiment, there is also a simple bill of materials (BOM) for the package. This allows for simpler assembly and test, with higher assembly yields and lower BOM cost. In an embodiment, there is enhanced scalability in number of PICs. There is also opportunity for per optical channel passive alignment (optimized for coupling loss) or per N-optical channels (e.g., one connector and registration per PIC), depending on the desirable balance between cost and performance. Also, such architectures are compatible with PIC and lens/mirror wafer-level manufacturing, assembly, and test processes. This reduces cost further. Additionally, architectures disclosed herein are compatible with known good optical FAU and PICs. This leads to a simple (top-access) per FAU test or per socket (many FAUs) test prior to assembly with the rest of the package. Embodiments disclosed herein are also easer to make in field upgrades (e.g., better fiber, or same fiber but upgraded LGA socket). While embodiments described above are vertical implementations, embodiments may also be used for side emission PICs, which allows for flexible socket integration.

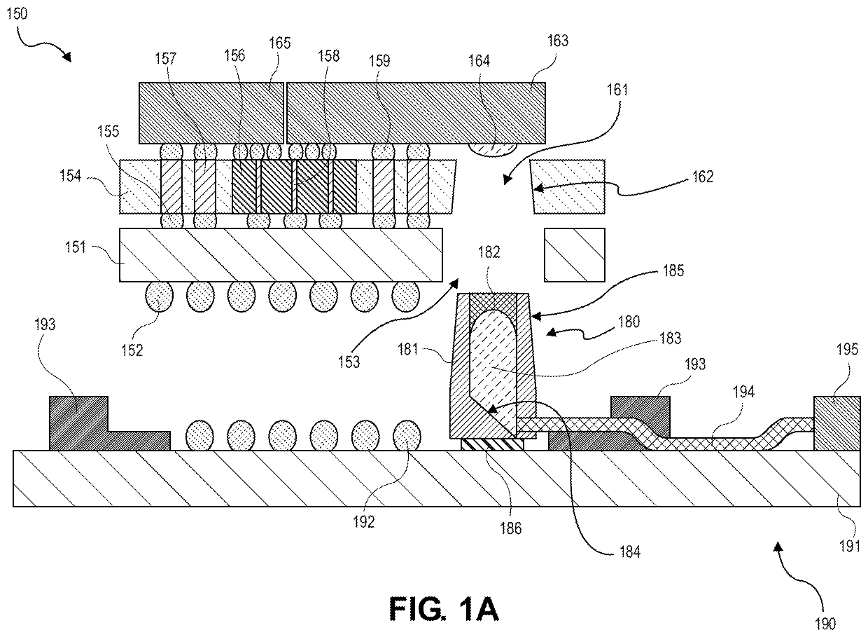

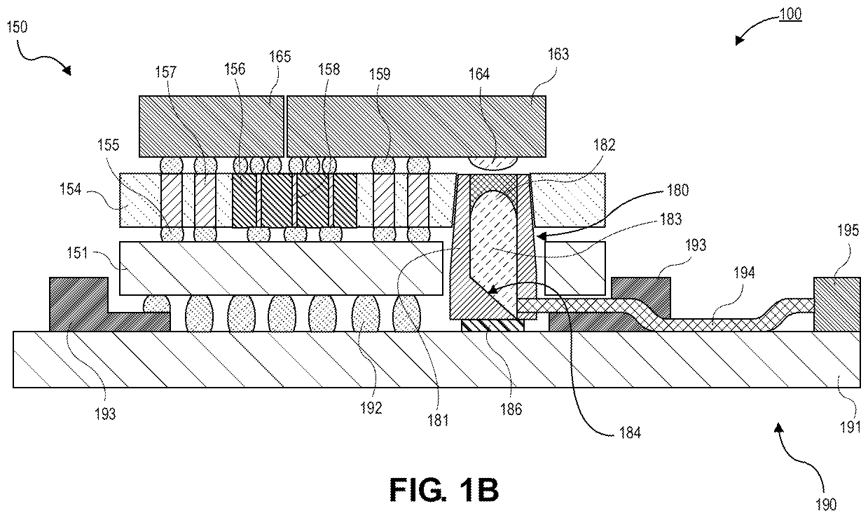

Referring now to FIG. 1A, a cross-sectional illustration of a PIC package 150 and a board 190 is shown, in accordance with an embodiment. In an embodiment, the board 190 may comprise a printed circuit board (PCB) substrate 191. In an embodiment, the PCB substrate 191 may include one or more dielectric layers and conductive routing (not shown). For example, the dielectric layers may be glass reinforced dielectric materials in some embodiments. The PCB substrate 191 may include a socket 193, for coupling with the PIC package 150. In an embodiment, solder balls 192 or other socket interconnects may be provided within the footprint of the socket 192.

In an embodiment, an optical connector 180 may be provided on the PCB board 191. The optical connector 180 may be within a footprint of the socket 193 in some embodiments. The optical connector 180 may include a housing 181 that surrounds an optical path. The optical path may include a lens 182, a fiber length 183, and a mirror 184. The optical connector 180 may be oriented so that the lens 182 faces upwards in a vertical direction. The mirror 184 may have an angle that directs the optical path laterally to an optical fiber 194 that is optically coupled to the optical connector 180. The optical fiber 194 may be coupled to an edge connector 195 or any other device.

In an embodiment, the optical connector 180 is configured to provide proper alignment of the lens 182 with a lens 164 on the PIC 163. For example, the optical connector 180 may have tapered sidewalls 185. The tapered sidewalls 185 interface with a hole 161 through an interposer 154. The hole 161 also includes tapered sidewalls 162 in order to properly guide the optical connector 180 to the proper position in the X-Y plane. Additionally, a compliant pad 186 may be provided under the optical connector 180. The compliant pad 186 allows for Z-position correction of the optical connector 185. The compliant pad 186 may be any suitable material, such as a polymer or the like. In other embodiments, the compliant pad 186 may comprise a spring-like structure.

In an embodiment, the PIC package 150 may comprise a package substrate 151. The package substrate 151 may comprise one or more dielectric layers with conductive features (e.g., traces, pads, vias, etc.) embedded in the package substrate 151. In some embodiments, the package substrate 151 may comprise a core, or the package substrate 151 may be coreless. On the board side of the package substrate 151 interconnects 152 may be provided. The interconnects 152 may interface with the socket 193 in order to electrically couple the package substrate 151 to the PCB board 191.

In an embodiment, the package substrate 151 may comprise an opening 153 that passes through the package substrate 151. The opening 153 may be aligned with the optical connector 180. As such, during coupling of the package substrate 151 to the PCB board 191, the optical connector 180 may pass through the package substrate 151. In some embodiments, the optical connector 180 passes entirely through a thickness of the package substrate 151, as will be described in greater detail below.

In an embodiment, the PIC package 150 may further comprise an interposer 154. The interposer 154 may be any suitable material. In a particular embodiment, the interposer 154 may be a glass substrate, a ceramic substrate, a composite substrate, or the like. In an embodiment, the interposer 154 may be coupled to the package substrate 151 by interconnects 155, such as solder balls or the like. In an embodiment, the interposer 154 may comprise conductive vias 157 that electrically couple the top of the interposer 154 to the bottom of the interposer 154. In some embodiments, a bridge 156 may also be embedded in the interposer 154. For example, the bridge 156 may be a silicon bridge 156. The bridge 156 may include high density routing (not shown) in order to couple the PIC 163 to a second die 165. In an embodiment, vias 158 (e.g., through silicon vias (TSVs)) may be provided through a thickness of the bridge 156.

Interconnects 159 may couple the PIC 163 and the second die 165 to the interposer 154. In an embodiment, the second die 165 may be an electrical die, such as a processor, a graphics processor, a memory, or any other die type. In an embodiment, the PIC 163 may be a die for converting optical signals to electrical signals and/or for converting electrical signals to optical signals. In an embodiment, the PIC 163 may include a lens 164. The lens 164 may be provided along a bottom surface of the PIC 163. That is, the lens 164 may face the interposer 154.

In an embodiment, the interposer 154 may include an opening 161. As noted above, the opening 161 may have a tapered sidewall 162 in order to provide physical alignment between the optical connector 180 and the lens 164. In an embodiment, the optical connector 180 may pass at least partially through a thickness of the interposer 154.

Referring now to FIG. 1B, a cross-sectional illustration of an electronic system 100 is shown, in accordance with an embodiment. In an embodiment, the electronic system 100 includes a PIC package 150 that is coupled to a board 190. The PIC package 150 and the board 190 may be substantially similar to the PIC package 150 and the board 190 described above with respect to FIG. 1A. In an embodiment, the PIC package 150 is connected to the board 190 through a socketing architecture 193. In other embodiments, a ball grid array (BGA) architecture may be used instead of a socket.

As shown, the optical connector 180 vertically passes through the package substrate 151. That is, the hole through the package substrate 151 may be wider than a maximum thickness of the optical connector 180. The optical connector 180 may also extend into the interposer 154. In the illustrated embodiment, the optical connector 180 does not pass entirely through a thickness of the interposer 154. In other embodiments, the optical connector 180 may pass entirely through a thickness of the interposer 154. The hole in the interposer 154 may have tapered sidewalls that interface with the optical connector 180 in order to properly align the lens 182 of the optical connector 180 with the lens 164 of the PIC 163. Since both ends include a lens, expanded beam coupling between the PIC 163 and the optical connector 180 is enabled. The expanded beam coupling allows for greater robustness and relaxed alignment tolerances between the lens 182 and the lens 164. The optical path may pass from the lens 164 to the lens 182, through the fiber length 183, reflect off the mirror 184, and couple with the optical fiber 194.

In the illustrated embodiment, a single optical connector 180 and lens 182 are shown. However, it is to be appreciated that additional lenses 182 may be provided out of the plane of FIG. 1B. In such embodiments, each lens 182 may have its own housing 181. That is, passive alignment may be provided for each of the lenses 182. In other embodiments, the number of alignment features may be smaller than the number of lenses 182. For example, a pair of alignment features may be used to properly align a set of three or more lenses 182. A first alignment feature may be at a first end of the lenses 182, and a second alignment feature may be at a second end of the lenses 182.

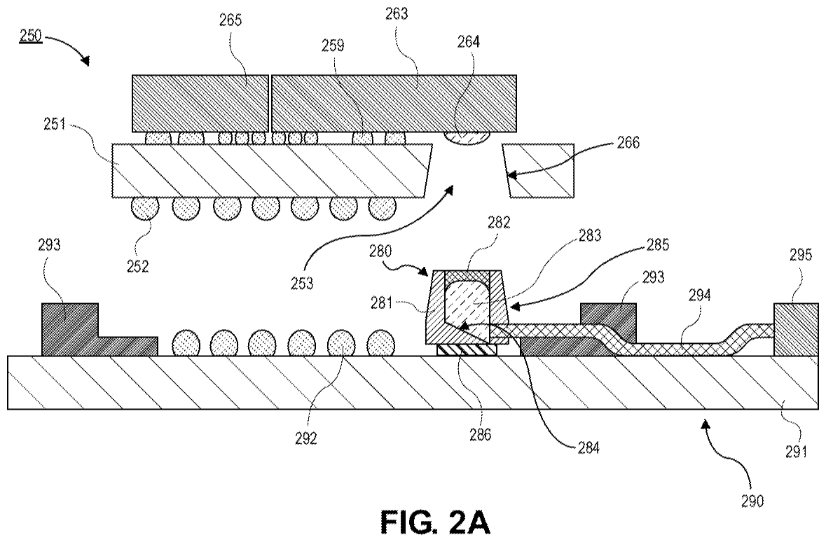

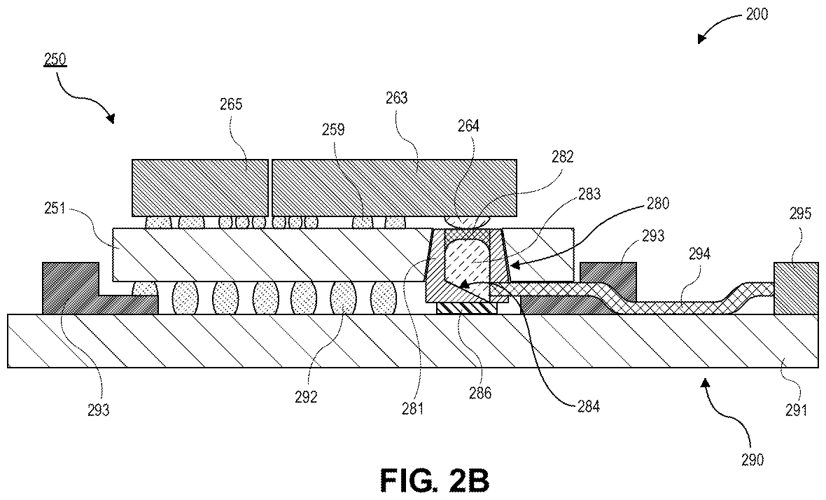

Referring now to FIGS. 2A and 2B, a pair of cross-sectional illustrations depicting an alternative embodiment is shown. Instead of including an interposer, the PIC packages 250 only include a package substrate.

Referring now to FIG. 2A, a cross-sectional illustration of a PIC package 250 and a board 290 is shown, in accordance with an embodiment. In an embodiment, the board 290 may comprise a PCB substrate 291. In an embodiment, the PCB substrate 291 may include one or more dielectric layers and conductive routing (not shown). For example, the dielectric layers may be glass reinforced dielectric materials in some embodiments. The PCB substrate 291 may include a socket 293, for coupling with the PIC package 250. In an embodiment, solder balls 292 or other socket interconnects may be provided within the footprint of the socket 293.

In an embodiment, an optical connector 280 may be provided on the PCB board 291. The optical connector 280 may be within a footprint of the socket 293 in some embodiments. The optical connector 280 may include a housing 281 that surrounds an optical path. The optical path may include a lens 282, a fiber length 283, and a mirror 284. The optical connector 280 may be oriented so that the lens 282 faces upwards in a vertical direction. The mirror 284 may have an angle that directs the optical path laterally to an optical fiber 294 that is optically coupled to the optical connector 280. The optical fiber 294 may be coupled to an edge connector 295 or any other device.

In an embodiment, the optical connector 280 is configured to provide proper alignment of the lens 282 with a lens 263 on the PIC 264. For example, the optical connector 280 may have tapered sidewalls 285. The tapered sidewalls 285 interface with a hole 253 through a package substrate 251. The hole 253 also includes tapered sidewalls 266 in order to properly guide the optical connector 280 to the proper position in the X-Y plane. Additionally, a compliant pad 286 may be provided under the optical connector 280. The compliant pad 286 allows for Z-position correction of the optical connector 280. The compliant pad 286 may be any suitable material, such as a polymer, spring or the like. In other embodiments, the compliant pad 286 may comprise a spring-like structure.

In an embodiment, the PIC package 250 may comprise a package substrate 251. The package substrate 251 may comprise one or more dielectric layers with conductive features (e.g., traces, pads, vias, etc.) embedded in the package substrate 251. In some embodiments, the package substrate 251 may comprise a core, or the package substrate 251 may be coreless. On the board side of the package substrate 251 interconnects 252 may be provided. The interconnects 252 may interface with the socket 293 in order to electrically couple the package substrate 251 to the PCB board 291.

In an embodiment, the package substrate 251 may comprise an opening 253 that passes through the package substrate 251. The opening 253 may be aligned with the optical connector 280. As such, during coupling of the package substrate 251 to the PCB board 291, the optical connector 280 may pass through the package substrate 251. In some embodiments, the optical connector 280 passes entirely through a thickness of the package substrate 251. The opening 253 may have a tapered sidewall 266 in order to provide physical alignment between the optical connector 280 and the lens 264.

Interconnects 259 may couple the PIC 263 and the second die 265 to the package substrate 251. In an embodiment, the second die 265 may be an electrical die, such as a processor, a graphics processor, a memory, or any other die type. In an embodiment, the PIC 263 may be a die for converting optical signals to electrical signals and/or for converting electrical signals to optical signals. In an embodiment, the PIC 263 may include a lens 264. The lens 264 may be provided along a bottom surface of the PIC 263. That is, the lens 264 may face the package substrate 251.

Referring now to FIG. 2B, a cross-sectional illustration of an electronic system 200 is shown, in accordance with an embodiment. In an embodiment, the electronic system 200 includes a PIC package 250 that is coupled to a board 290. The PIC package 250 and the board 290 may be substantially similar to the PIC package 250 and the board 290 described above with respect to FIG. 2A. In an embodiment, the PIC package 250 is connected to the board 290 through a socketing architecture 293. In other embodiments, a BGA architecture may be used instead of a socket.

As shown, the optical connector 280 is vertically inserted into the package substrate 251. In some embodiments, the optical connector 280 passes partially through the package substrate 251. In other embodiments, the optical connector 280 may pass entirely through a thickness of the package substrate 251. The hole in the package substrate 251 may have tapered sidewalls that interface with the optical connector 280 in order to properly align the lens 282 of the optical connector 280 with the lens 264 of the PIC 263. Since both ends include a lens, expanded beam coupling between the PIC 263 and the optical connector 280 is enabled. The expanded beam coupling allows for greater robustness in the proper alignment between the lens 282 and the lens 264. The optical path may pass from the lens 264 to the lens 282, through the fiber length 283, reflect off the mirror 284, and couple with the optical fiber 294.

In the illustrated embodiment, a single optical connector 280 and lens 282 are shown. However, it is to be appreciated that additional lenses 282 may be provided out of the plane of FIG. 2B. In such embodiments, each lens 282 may have its own housing 281. That is, passive alignment may be provided for each of the lenses 282. In other embodiments, the number of alignment features may be smaller than the number of lenses 282. For example, a pair of alignment features may be used to properly align a set of three or more lenses 282. A first alignment feature may be at a first end of the lenses 282, and a second alignment feature may be at a second end of the lenses 282.

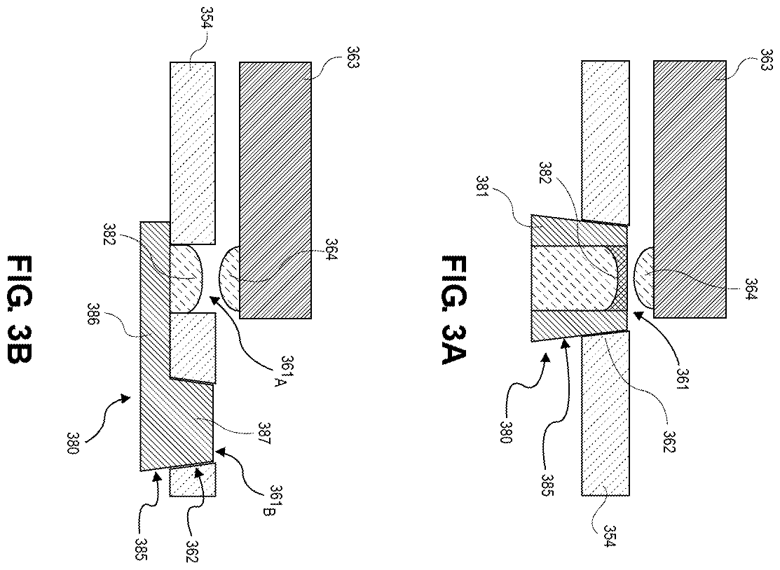

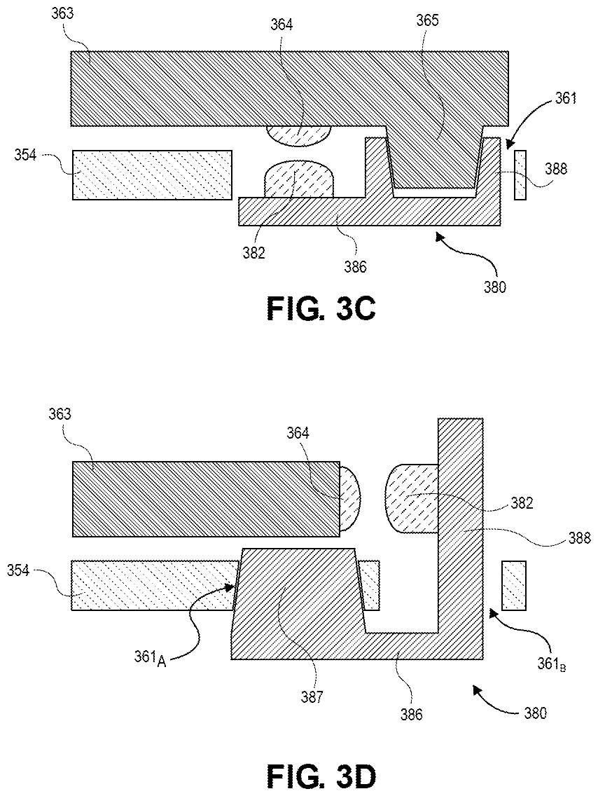

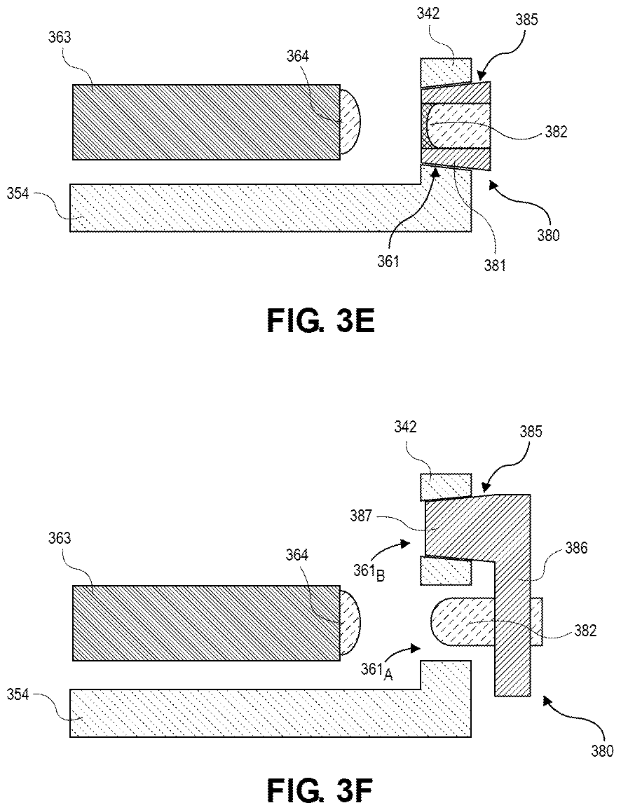

Referring now to FIGS. 3A-3F, a series of cross-sectional illustrations of optical connectors and PICs is shown, in accordance with an embodiment. Particularly, the embodiments shown in FIGS. 3A-3F illustrate different alignment architectures that may be used in combination with an electronic system, such as the electronic systems 100 and 200 described in greater detail above. In the illustrated embodiments, the alignment features interface with an interposer. However, it is to be appreciated that similar structures may be used in instances where the interposer is omitted. In such embodiments, the alignment feature of the optical connector may interface directly with the package substrate.

Referring now to FIG. 3A, a cross-sectional illustration of an optical interconnect architecture is shown, in accordance with an embodiment. In an embodiment, a PIC 363 may be provided over an underlying interposer 354. The interposer 354 may be a glass interposer 354 a ceramic interposer, a composite interposer or the like. A PIC lens 364 may be provided between the PIC 363 and the interposer 354. That is, the lens 364 may face in the downwards direction. In an embodiment lens 364 may be a beam expansion and collimation feature. For example, lens 364 may comprise a lens and a mirror or only mirrors. In an embodiment, the lens 364 may be part of the PIC 363, an additive element to the PIC, or a hybrid of the two.

In an embodiment, the interposer 354 comprises a hole 361. The hole 361 may pass entirely through a thickness of the interposer 354. In an embodiment, the hole 361 may have a tapered sidewall 362. The tapered sidewall 362 allows for mechanical alignment of an optical connector 380 to the lens 364. The lens 364 may be positioned directly over the hole 361. In an embodiment, the optical connector 380 may include a housing 381 that surrounds a lens 382. The housing 381 may have a tapered sidewall 385 in order to interface with the tapered sidewall 362 of the hole 361 through the interposer 354. As such, the lens 364 can be properly aligned in the X-Y plane with the lens 382 in order to enable expanded beam coupling.

Referring now to FIG. 3B, a cross-sectional illustration of an optical interconnect architecture is shown, in accordance with an additional embodiment. As shown, the PIC 363 is provided over an interposer 354. The PIC 363 may include a lens 364 that faces down towards the interposer 354. In an embodiment, the interposer 354 includes a first opening 361A and a second opening 361B. A lens 382 of the optical connector 380 may pass through the first opening 361A. The second opening 361E may be used as the alignment feature. That is, the position of the lens 382 and the alignment feature 387 of the optical connector 380 do not need to be co-located with each other. Instead, the alignment feature 387 may be connected to the lens 382 by a beam 386 or the like. In an embodiment, the alignment feature 387 includes a tapered sidewall 385 that interfaces with a tapered sidewall 362 of the second opening 361B.

Referring now to FIG. 3C, a cross-sectional illustration of an optical interconnect architecture is shown, in accordance with an additional embodiment. As shown, the PIC 363 includes a lens 364 that faces downwards towards an interposer 354. In an embodiment, the interposer 354 includes an opening 361. The optical connector 380 passes up through the hole 361 in order to couple with the PIC 363. Particularly, the optical connector 380 includes an alignment feature 388. The alignment feature 388 may have a cutout in order to receive a protrusion 365 from the PIC 363. The protrusion 365 and the alignment feature 388 may have tapered sidewalls in order to set the proper alignment. In an embodiment, the optical connector 380 may include a lens 382 that is on a beam 386 that extends to the alignment feature 388.

Referring now to FIG. 3D, a cross-sectional illustration of an optical interconnect architecture is shown, in accordance with an additional embodiment. As shown, the PIC 363 is provided over the interposer 354. However, unlike other embodiments described above, the lens 364 is provided on a sidewall of the PIC 363. As such, the optical connector 380 includes a vertical feature 388 and a lens 382. In the illustrated embodiment, the vertical feature 388 extends up through a second hole 361E in the interposer 354. However, it is to be appreciated that the vertical feature 388 may pass outside of the interposer 354 and there may not be a need for the second hole 361B. An alignment feature 387 passes through a first hole 361A of the interposer 354. The alignment feature 387 may be coupled to the vertical feature 388 by a beam 386. In an embodiment, the alignment feature 387 and the first hole 361A have tapered sidewalls in order to provide accurate alignment.

Referring now to FIG. 3E, a cross-sectional illustration of an optical interconnect architecture is shown, in accordance with yet another embodiment. In the illustrated embodiment, the interposer 354 includes a vertical portion 342. In an embodiment, a hole 361 is provided through the vertical portion 342. The optical connector 380 includes a lens 382 that is co-located with the housing 381 that serves as the alignment feature. As shown, the housing 381 includes a tapered sidewall 385 in order to interface with the tapered sidewall of the hole 361. Similar to the embodiment shown in FIG. 3D, the lens 364 on the PIC 363 is provided on a sidewall of the PIC 363.

Referring now to FIG. 3F, a cross-sectional illustration of an optical interconnect architecture is shown, in accordance with an additional embodiment. In the illustrated embodiment, the vertical portion 342 of the interposer 354 includes a pair of holes 361A and 361B. The lens 382 of the optical connector 380 passes through the first hole 361A, and the alignment feature 387 is inset into the second hole 361B. That is, the alignment feature 387 and the lens 382 need not be co-located in some embodiments. In an embodiment, a sidewall 385 of the alignment feature 387 is tapered to interface with a tapered sidewall of the second opening 361B. Similar to the embodiment in FIG. 3E, the lens 364 of the PIC 363 is provided on a sidewall of the PIC 363.

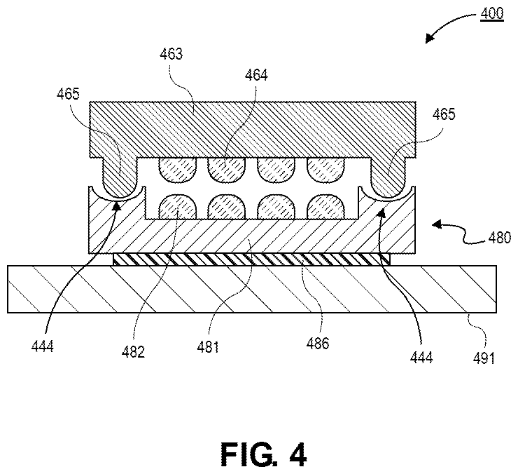

Referring now to FIG. 4, a cross-sectional illustration of an optical interconnect architecture 400 is shown, in accordance with an embodiment. As shown, an optical connector 480 includes a plurality of lenses 482 that are provided over a housing 481. The housing 481 may include alignment features 444 at the ends of the housing 481. The alignment features 444 may be recesses or depressions into the housing 481. The housing 481 may be provided over a compliant pad 486, such as a polymer or a spring type structure. In an embodiment, the PIC 463 may include lenses 464 that face down toward the lenses 482 of the optical connector 480. In an embodiment, the PIC 463 includes protrusions 465 that set into the alignment features 444 of the optical connector 480. With vibration, the PIC 463 settles to its lowest energy point and the lenses 464 are aligned with the lenses 482.

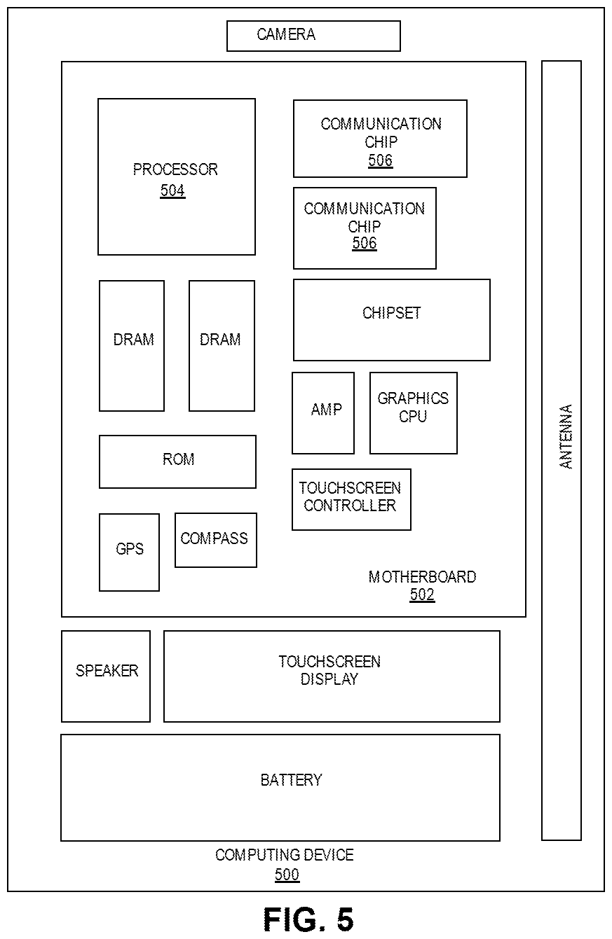

FIG. 5 illustrates a computing device 500 in accordance with one implementation of the invention. The computing device 500 houses a board 502. The board 502 may include a number of components, including but not limited to a processor 504 and at least one communication chip 506. The processor 504 is physically and electrically coupled to the board 502. In some implementations the at least one communication chip 506 is also physically and electrically coupled to the board 502. In further implementations, the communication chip 506 is part of the processor 504.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 506 enables wireless communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 500 may include a plurality of communication chips 506. For instance, a first communication chip 506 may be dedicated to shorter range wireless communications such as Wi-Fi and Bluetooth and a second communication chip 506 may be dedicated to longer range wireless communications such as GPS, EDGE, GPRS, CDMA, WiMAX, LTE, Ev-DO, and others.

The processor 504 of the computing device 500 includes an integrated circuit die packaged within the processor 504. In some implementations of the invention, the integrated circuit die of the processor may part of an electronic package that includes a PIC with an optical connector that allows for expanded beam coupling, in accordance with embodiments described herein. The term “processor” may refer to any device or portion of a device that processes electronic data from registers and/or memory to transform that electronic data into other electronic data that may be stored in registers and/or memory.

The communication chip 506 also includes an integrated circuit die packaged within the communication chip 506. In accordance with another implementation of the invention, the integrated circuit die of the communication chip may part of an electronic package that includes a PIC with an optical connector that allows for expanded beam coupling, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: an electronic system, comprising: a board; a package substrate coupled to the board; a photonics integrated circuit (PIC) coupled to the package substrate; an optical lens on the PIC; and an optical connector on the board, wherein the optical connector passes through an opening through the package substrate and is optically coupled with the optical lens on the PIC.

Example 2: the electronic system of Example 1, wherein sidewalls of the optical connector are tapered, and wherein sidewalls of the opening through the package substrate are tapered.

Example 3: the electronic system of Example 1 or Example 2, further comprising: an interposer between the PIC and the package substrate.

Example 4: the electronic system of Example 3, wherein the optical connector passes through a second opening through the interposer.

Example 5: the electronic system of Example 4, wherein sidewalls of the optical connector are tapered, and wherein sidewalls of the opening through the interposer are tapered.

Example 6: the electronic system of Example 3, wherein the interposer is a glass interposer.

Example 7: the electronic system of Examples 1-6, wherein the optical connector comprises a second lens and a mirror.

Example 8: the electronic system of Example 7, wherein the mirror is coupled to an optical fiber.

Example 9: the electronic system of Example 8, wherein the optical fiber extends to an edge of the board.

Example 10: the electronic system of Examples 1-9, wherein the package substrate couples to the board with a socketing interconnect architecture.

Example 11: the electronic system of Examples 1-10, further comprising: a compliant pad under the optical connector.

Example 12: the electronic system of Example 11, wherein the compliant pad is a spring.

Example 13: the electronic system of Examples 1-12 wherein the lens is on a surface of the PIC that faces the package substrate.

Example 14: the electronic system of Examples 1-13, wherein the lens is on a side of the PIC.

Example 15: the electronic system of Examples 1-14, wherein the optical connector comprises: a second lens; and an alignment feature, wherein the second lens and the alignment feature are not co-located.

Example 16: the electronic system of Examples 1-15, wherein the alignment feature is a well into which a protrusion of the PIC sits, or wherein a well is in the PIC and a protrusion sits into the well of the PIC.

Example 17: a printed circuit board (PCB), comprising: a PCB substrate; a socket configured to interface with an electronic package; an optical connector; and an optical fiber coupled to the optical connector.

Example 18: the PCB of Example 17, wherein the optical connector is within a footprint of the socket.

Example 19: the PCB of Example 17 or Example 18, further comprising: a compliant pad under the optical connector.

Example 20: the PCB of Examples 17-19, wherein the optical connector comprises: a lens; and a mirror, wherein the lens is optically coupled to the optical fiber by the mirror.

Example 21: the PCB of Example 20, wherein optical connector further comprises: a housing around the lens and the mirror, and wherein the housing has a tapered sidewall surface.

Example 22: the PCB of Examples 17-21, wherein the optical fiber extends to an edge of the PCB substrate.

Example 23: an electronic system, comprising: a board; a package substrate coupled to the board; an interposer coupled to the package substrate, wherein the interposer comprises glass; a photonics integrated circuit (PIC) coupled to the interposer; an optical lens on the PIC; and an optical connector on the board, wherein the optical connector passes through a first opening through the package substrate and a second opening through the interposer, wherein the optical connector is optically coupled with the optical lens on the PIC, wherein sidewalls of the second opening are tapered, and wherein sidewalls of the optical connector are tapered.

Example 24: the electronic system of Example 23, further comprising a die coupled to the PIC, wherein the die is coupled to the PIC through a bridge on the interposer.

Example 25: the electronic system of Example 23 or Example 24, wherein the optical connector comprises a second lens and a mirror, wherein the second lens is coupled to an optical fiber by the mirror.

What is claimed is:

1. An electronic system, comprising:
a board;
a package substrate coupled to the board;
a photonics integrated circuit (PIC) coupled to the package substrate;
an optical lens on the PIC; and
an optical connector on the board, wherein the optical connector passes through an opening through the package substrate and is optically coupled with the optical lens on the PIC.

2. The electronic system of claim 1, wherein sidewalls of the optical connector are tapered, and wherein sidewalls of the opening through the package substrate are tapered.

3. The electronic system of claim 1, further comprising:
an interposer between the PIC and the package substrate.

4. The electronic system of claim 3, wherein the optical connector passes through a second opening through the interposer.

5. The electronic system of claim 4, wherein sidewalls of the optical connector are tapered, and wherein sidewalls of the opening through the interposer are tapered.

6. The electronic system of claim 3, wherein the interposer is a glass interposer.

7. The electronic system of claim 1, wherein the optical connector comprises a second lens and a mirror.

8. The electronic system of claim 7, wherein the mirror is coupled to an optical fiber.

9. The electronic system of claim 8, wherein the optical fiber extends to an edge of the board.

10. The electronic system of claim 1, wherein the package substrate couples to the board with a socketing interconnect architecture.

11. The electronic system of claim 1, further comprising:
a compliant pad under the optical connector.

12. The electronic system of claim 11, wherein the compliant pad is a spring.

13. The electronic system of claim 1 wherein the lens is on a surface of the PIC that faces the package substrate.

14. The electronic system of claim 1, wherein the lens is on a side of the PIC.

15. The electronic system of claim 1, wherein the optical connector comprises:
a second lens; and
an alignment feature, wherein the second lens and the alignment feature are not co-located.

16. The electronic system of claim 1, wherein the alignment feature is a well into which a protrusion of the PIC sits, or wherein a well is in the PIC and a protrusion sits into the well of the PIC.

17. A printed circuit board (PCB), comprising:
a PCB substrate;
a socket configured to interface with an electronic package;
an optical connector; and
an optical fiber coupled to the optical connector.

18. The PCB of claim 17, wherein the optical connector is within a footprint of the socket.

19. The PCB of claim 17, further comprising:
a compliant pad under the optical connector.

20. The PCB of claim 17, wherein the optical connector comprises:
a lens; and
a mirror, wherein the lens is optically coupled to the optical fiber by the mirror.

21. The PCB of claim 20, wherein optical connector further comprises:
a housing around the lens and the mirror, and wherein the housing has a tapered sidewall surface.

22. The PCB of claim 17, wherein the optical fiber extends to an edge of the PCB substrate.

23. An electronic system, comprising:
a board;
a package substrate coupled to the board;
an interposer coupled to the package substrate, wherein the interposer comprises glass;
a photonics integrated circuit (PIC) coupled to the interposer;
an optical lens on the PIC; and
an optical connector on the board, wherein the optical connector passes through a first opening through the package substrate and a second opening through the interposer, wherein the optical connector is optically coupled with the optical lens on the PIC, wherein sidewalls of the second opening are tapered, and wherein sidewalls of the optical connector are tapered.

24. The electronic system of claim 23, further comprising a die coupled to the PIC, wherein the die is coupled to the PIC through a bridge on the interposer.

25. The electronic system of claim 23, wherein the optical connector comprises a second lens and a mirror, wherein the second lens is coupled to an optical fiber by the mirror.
